(19) United States
(12) Patent Application Publication
(10) Pub. No.: US 2020/0300342 A1
(43) Pub. Date: Sep. 24, 2020

(54) MECHANICAL AMPLIFIER DEVICES AND APPLICATIONS

(71) Applicant: Nolan Hollingsworth, Baytown, TX (US)

(72) Inventor: Nolan Hollingsworth, Baytown, TX (US)

(21) Appl. No.: 16/827,664

(22) Filed: Mar. 23, 2020

Related U.S. Application Data
(60) Provisional application No. 62/822,801, filed on Mar. 23, 2019.

(51) Int. Cl. F16H 21/48; B62M 1/36

(52) U.S. Cl. CPC F16H 21/48; B62M 1/36

(57) ABSTRACT

Disclosed is a mechanical amplifier device and mechanism thereof. The mechanical amplifier device comprises an input shaft, a housing and an output shaft. The input shaft receives an initial force as an input which is provided to a first wheel, thus enabling synchronous rotation of the first wheel. A lever is configured to receive the initial force from the first wheel, while the lever is attached to an outer edge of the first wheel, enabling rotation of the lever to amplify the initial force. The lever passes through a center of a fulcrum and attaches to an outer edge of a second wheel to provide the amplified initial force to the second wheel, which causes rotation of the second wheel. The output shaft then rotates synchronously upon receiving the amplified initial force from the second wheel and provides the amplified initial force to an external machine such as a bicycle.

### RELATED APPLICATION AND CLAIM OF PRIORITY

This application is related to and claims priority from U.S. Provisional Patent Application No. 62/822,801 to common inventor Nolan Hollingsworth and entitled ROTATIONAL ENERGY/FORCE AMPLIFIER filed on Mar. 23, 2019.

### TECHNICAL FIELD

The present invention is generally related to increasing efficiency of machines, and more particularly, is related to mechanical amplifier devices.

### STATEMENT OF PROBLEMS ADDRESSED BY THIS INVENTION

### Interpretation Considerations

This section describes technical field in detail and discusses problems encountered in the technical field. Therefore, statements in the section are not to be construed as prior art.

### Discussion of History of the Problem

A mechanical amplifier, such as a force amplifier, a torque amplifier, etc. take an initial input in the form of energy, amplifies the input, and convert the amplified input into rotational energy or force. Stated differently, a mechanical amplifier, also known as a mechanical amplifying element, is a linkage mechanism that amplifies the magnitude of mechanical quantities such as force, displacement, velocity, energy, acceleration and torque in linear and rotational systems. Similarly, a torque amplifier amplifies a torque of a rotating shaft.

Unfortunately, the conventional mechanical amplifiers remain stubbornly inefficient and fails to increase power and reduce energy consumption of the existing motors/engines and bicycles in a desired manner and have complex designs thus are expensive to install. Accordingly, there exist the need for improved systems and features that increase the efficiency of the existing motors/engines and bicycles. The present invention provides such systems, methods and devices.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

A mechanical amplifier device is provided substantially, as shown in and/or described in connection with at least one of the figures, as set forth more completely in the claims.

According to the embodiments illustrated herein, a mechanical amplifier device is provided. The device includes an input shaft, a housing and an output shaft. The housing includes a first wheel, a second wheel, a fulcrum housing, a fulcrum, a lever, an input shaft bearing, an output shaft bearing, a first connection point, and a second connection point.

The input shaft is configured to receive an initial force. The initial input may be originated from any source such as a lever, a button, a motor, an engine, a crank, a pump, wind and/or water movement, a pulley system, hydraulic means, gravity, organisms, etc. that could be amplified and then utilized to drive existing motors/engines used in automobiles, planes, boats, generators, power plants, home appliances, tools, toys, etc. and bicycles, tricycles or the like with lesser efforts.

The first wheel is configured to receive the initial force from the input shaft, wherein the input shaft enables synchronous rotation of the first wheel. A lever is configured to receive the initial force transferred from the first wheel, while the lever is attached to an outer edge of the first wheel, enabling rotation of the lever to amplify the initial force. The lever further passes through a center of a fulcrum accommodated in a fulcrum housing and attaches to an outer edge of a second wheel to provide the amplified initial force to the second wheel. Once the lever has passed through the center of the fulcrum, the first wheel is connected to the second wheel. The amplified initial force, transferred to the second wheel, causes rotation of the second wheel.

The output shaft is configured to rotate synchronously upon receiving the amplified initial force from the second wheel and configured to provide the amplified initial force to an external machine such a bicycle. In a first embodiment, the initial force is an external force generated from sources such as a lever, a button, a motor, an engine, a crank, a pump, wind movement, water movement, a pulley system, hydraulic means, gravity, or animals (including humans).

In one embodiment, a longer end of the lever is attached to the outer edge of the first wheel at a first connection point and a shorter end of the lever is attached to the outer edge of the second wheel at a second connection point. The fulcrum and the lever are configured to accept force in a 360 degree range of motion.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. A person with ordinary skill in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a perspective side view of a mechanical amplifier device;

FIG. 2 illustrates an isometric view of the mechanical amplifier device;

FIG. 3 illustrates a perspective side view of the mechanical amplifier device from an output shaft end side;

FIG. 4 illustrates an isometric side view of the mechanical amplifier device from the output shaft end side; and

FIG. 5 illustrates an example bicycle connected with the mechanical amplifier device.

### DESCRIPTION OF AN EXEMPLARY PREFERRED EMBODIMENT

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated.

The present disclosure is best understood with reference to the detailed figures and description set forth herein. Various specific embodiments have been discussed with reference to the figures. However, those skilled in the art will readily appreciate that the detailed description provided herein with respect to the figures are for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily includes that particular feature, structure, characteristic, property, element, or limitation. Furthermore, repeated use of phrases related to embodiments (such as “in an embodiment”) does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents, unless the context clearly dictates otherwise. In the claims, the terms “first”, “second”, and so forth are to be interpreted merely as ordinal designations; they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

The expression ‘input means’ or ‘input shaft’ may be interchangeably used without departing from the meaning and scope of the present invention. The expression ‘output means’ or ‘output shaft’ may be interchangeably used without departing from the meaning and scope of the present invention. The expression ‘force’ or ‘energy’ may be interchangeably used without departing from the meaning and scope of the present invention. The expression ‘mechanical amplifier device’ or ‘rotational force/energy amplifier’ may be interchangeably used without departing from the meaning and scope of the present invention.

### Description of the Drawings

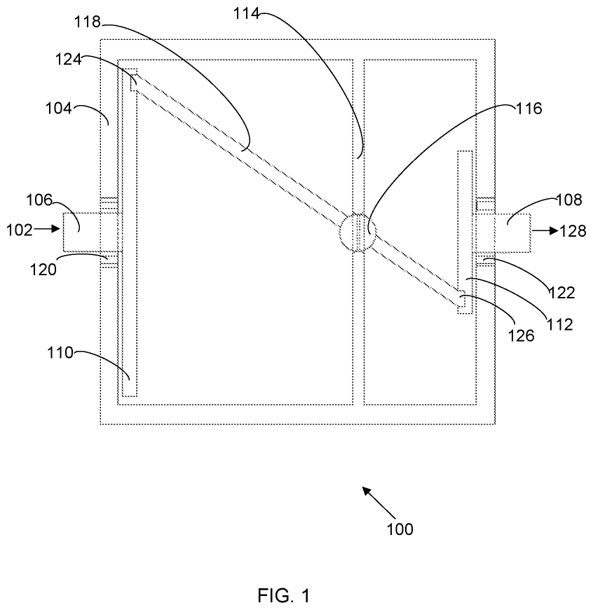

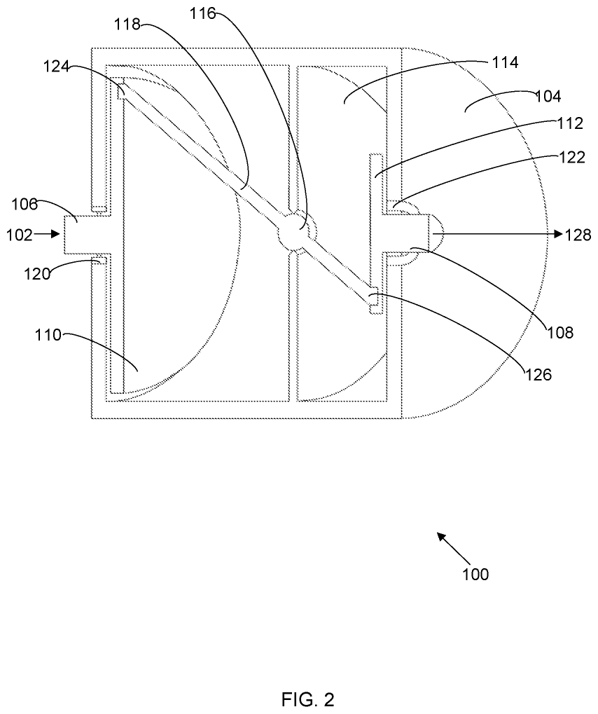

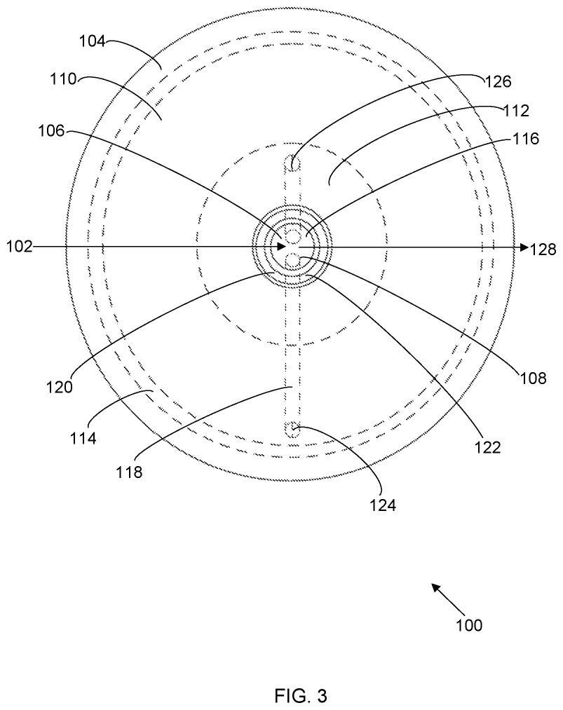

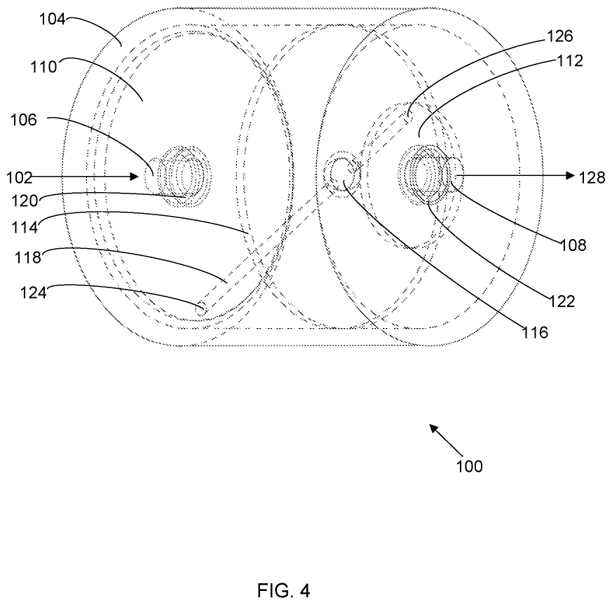

Simultaneous reference is made with respect to FIGS. 1-4, in which FIG. 1 illustrates a perspective side view of a mechanical amplifier device, FIG. 2 illustrates an isometric view of the mechanical amplifier device, FIG. 3 illustrates a perspective side view of the mechanical amplifier device from an output shaft end side, and FIG. 4 illustrates an isometric side view of the mechanical amplifier device from the output shaft end side.

The mechanical amplifier device 100 comprises an input means 106, a housing 104 and an output means 108. The input means 106 is configured to receive an input 102 and the output means 108 is configured to produce an amplified output 128, wherein the input means 106 and the output means 108 are placed along a horizontal axis. The housing comprises a first wheel 110, a second wheel 112, a fulcrum housing 114, a fulcrum 116, a lever 118, an input shaft bearing 120, an output shaft bearing 122, a first connection point 124, and a second connection point 126.

The input 102 may be, but not limited to, an external force or energy generated from sources such as a lever, a button, a motor, an engine, a crank, a pump, wind movement, water movement, a pulley system, hydraulic means, gravity, organisms, etc. The input 102 is received by the housing 104 via the input means 106 connected to the housing 104. In some embodiments, the input means 106 is an input shaft, which is connected with the input shaft bearing 120 to enable rotational movement, while reducing friction and handling stress. The input means 106 is attached to the first wheel 110 and is fixed in synchronous rotation with the input means 106. Once the input 102 (i.e. the external force) is applied, the input shaft 106 starts rotating and results in synchronous rotation of the first wheel 110 connected to it.

The lever 118 is attached to an outer edge of the first wheel 110 at the first connection point 124 from one end, wherein the first wheel 110 transfers the external force into the lever 118, resulting in rotation of the lever 118. In other words, the longer end of the lever 118 is attached to the outer edge of the first wheel 110. In general, a lever is a rigid body pivoted at a fulcrum or a fixed hinge and is capable of rotating on a point. Here, the lever 118 amplifies the input force and provides a greater output force.

In an embodiment, the lever 118 is fixed in place along the same horizontal axis as the input means 106 and the output means 108. While the lever 118 is still attached to the first wheel 110, the lever 118 passes through a center of the fulcrum 116, wherein the fulcrum is placed in the fulcrum housing 114. After passing through the center of the fulcrum 116, another end of the lever 118 attaches to an outer edge of the second wheel 112 at the second connection point 126, thereby connects the first wheel 110 to the second wheel 112. In other words, the shorter end of the lever 118 attaches to the second wheel 112 at the second connection point 126.

In this connection process, the pivotal movement of the lever 118 results in an amplified rotational force which is then passes onto the second wheel 112. The second wheel 112 starts rotating and transfers the amplified rotational force to the output means 108 enabling the output means 108 to rotate synchronously with the second wheel 112. The output means 108 is an output shaft, which is connected with the output shaft bearing 122 to enable rotational movement, while reducing friction and handling stress.

The amplified rotational force 128 may be utilized by and passed onto to other external machines via the output shaft 108 to accomplish more work which was originally not feasible with the initial external force/energy 102. Thus, the process provises an immediate angular momentum amplification without creating an angular velocity amplification.

The input shaft 106 and the output shaft 108 may be a drive shaft or a transmission shaft such as a counter shaft, a line shaft, an overhead shaft or a machine shaft such as a crankshaft or other possible rotational shafts that is capable of handling shear stress, bending stress, or other induced stress. Further, the drive shaft may be a one piece drive shaft, a two piece drive shaft, a slip in tube drive shaft or other suitable shaft. Furthermore, the drive shaft may have a torque tube design, a Hotchkiss design, Camden design, or equivalent.

The fulcrum housing 114 is a 360 degree fulcrum housing. Other variations are also possible. The fulcrum 116 and the lever 118 are configured to accept force in a 360 degree range of motion fixed upon a central axis. The fulcrum may be a lever bearing or a heim joint or other suitable joint. The lever may be a class 1 type lever, a class 2 type lever or a class 3 type lever. The lever may be more than one. The first connection point 124, and the second connection point 126 may be a lever or a disc connection point. In an embodiment, the first wheel 110 is larger than the second wheel 112. In an alternative embodiment, the first wheel 110 is smaller than the second wheel 112.

Generally, the housing 104 and all the other components in the housing 104 are made of a metal or plastic or rubber or other industrial grade composites.

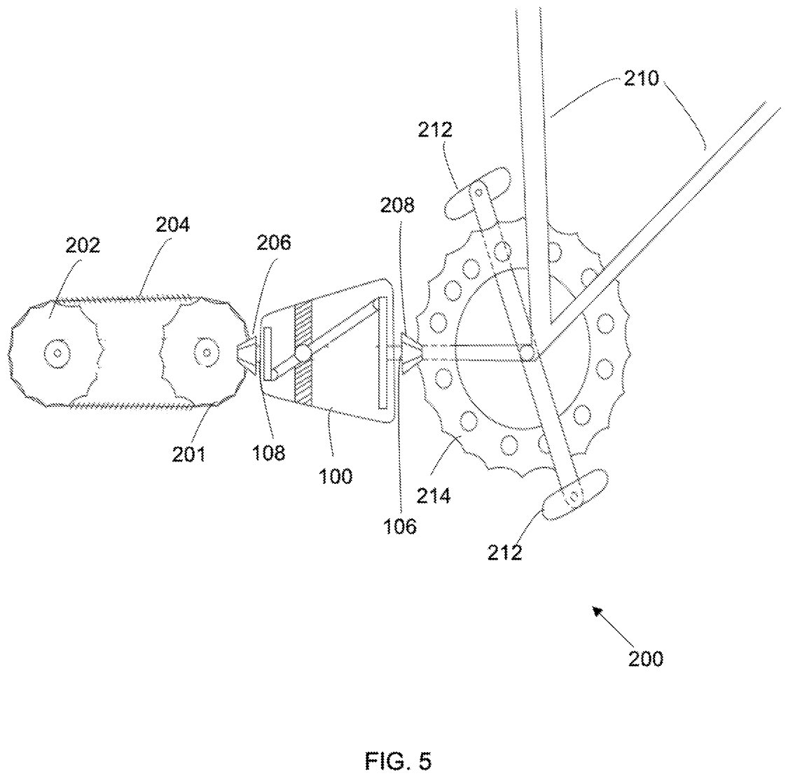

FIG. 5 illustrates an example bicycle connected with the mechanical amplifier device. The bicycle 200 comprises a sprocket 202, a chain 204, a first gear 206, a mechanical amplifier device 100, a second gear 208, a bicycle frame 210, and a pair of pedals 212. The sprockets 201, 202 are commonly available standard sprockets or wheels with teeth or cogs that forms a mesh with the chain 204 or with other intended mate. The sprockets 201, 202 may be the same size as shown, or of differing sizes where the sprocket 202 is larger or smaller than the sprocket 201. This combination i.e. the combination of the sprockets 201, 202 and the chain 204 works as a drive system and is used to transmit rotary motion to the wheels of the bicycles, bikes or the like.

The first gear 206, from one end, is attached to and interlocks the sprocket 202 and from another end is connected to the mechanical amplifier device 100. Similarly, the second gear 208, from one end, is attached to and interlocks a pedal bike teeth 214 and from another end is connected to the mechanical amplifier device 100. In an embodiment, there are two gears. In alternative embodiment, the gears are less than two. In alternative embodiment, the gears are more than two.

The gears may be a parallel axes gear such as a spur gear, a helical gear, an internal gear or an intersecting axes gear such as a miter gear, a straight bevel gear, a spiral bevel gear or a nonparallel, nonintersecting axes gear such as a screw gear, a worm gear or any combination thereof. In an embodiment, the first gear 206 and second gear 208 are angular gears with shaft angles in the range of 45 degrees to 120 degrees. In alternative embodiment, the first gear 206 and second gear 208 are the gears with shaft angle of 45 degrees.

Upon pedalling the bicycle 200 through the pair of pedals 212, an input rotational force or energy is provided to the mechanical amplifier device 100 through an input shaft 106. As mentioned above, the input to the mechanical amplifier device 100 may be, but not limited to, an external force or energy generated from sources such as a lever, a button, a motor, an engine, a crank, a pump, wind movement, water movement, a pulley system, hydraulic means, gravity, organisms, etc. Here, the input rotational force or energy is provided by pedalling. The input through other aforementioned means are also possible. Once the input i.e. the external force is applied, the input shaft 106 connected to the second gear 208 starts rotating and results in synchronous rotation of the first wheel 110 connected to it.

The lever 118 is attached to an outer edge of the first wheel 110 at the first connection point 124 from one end, wherein the first wheel 110 transfers the external force into the lever 118, resulting in rotation of the lever 118. In other words, the longer end of the lever 118 is attached to the outer edge of the first wheel 110. In general, a lever is a rigid body pivoted at a fulcrum or a fixed hinge and is capable of rotating on a point. The lever 118 amplifies the input force and provides a greater output force.

In an embodiment, the lever 118 is fixed in place along the same horizontal axis as the input means 106 and the output means 108. While the lever 118 is still attached to the first wheel 110, the lever 118 passes through a center of the fulcrum 116 which is placed in the fulcrum housing 114. After passing through the center of the fulcrum 116, another end of the lever 118 attaches to an outer edge of the second wheel 112 at the second connection point 126, thereby connects the first wheel 110 to the second wheel 112. In other words, the shorter end of the lever 118 attaches to the second wheel 112 at the second connection point 126.

In this connection process, the pivotal movement of the lever 118 results in an amplified rotational force which is then passes onto the second wheel 112. The second wheel 112 starts rotating and transfers the amplified rotational force to the output means 108 enabling the output means 108 to rotate synchronously with the second wheel 112. The output means 108 is an output shaft, which is connected with the output shaft bearing 122 to enable rotational movement, while reducing friction and handling stress.

The amplified rotational force 128 is then utilized by and passed onto to the bicycle via the output shaft 108 to provide desired speed that was originally not feasible with the initial external force/energy provided using pedalling. Further, the amplified rotational force or energy is diverted back from the output side of the mechanical amplifier device via a belt and a pulley and/or a lever and a fulcrum or any other mechanical means and then transferred to the start again.

In an embodiment, the fulcrum housing 114 is a 360 degree fulcrum housing. Other variations are also possible. For example, a fulcrum 116 and the lever 118 may be configured to accept force in a 360 degree range of motion fixed upon a central axis. The fulcrum may be a lever bearing or a heim joint or other suitable joint. The lever may be a class 1 type lever, a class 2 type lever or a class 3 type lever, and may be a compound lever.

In an embodiment, the mechanical amplifier device 100 may be installed into existing bicycles. In another embodiment, the bicycle may have factory installed mechanical amplifier device 100.

Thus, the present invention provides a set-up and a mechanism to amplify and provide rotational force or energy by using a simple lever and fulcrum and/or pulley system, either alone or in combination with hydraulics. This simple set-up reduces the cost of manufacturing and enhances the efficiency of the connected bicycles, motors or engines.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention cover the modifications and variations of this invention, provided they are within the scope of the appended claims and their equivalents.

What is claimed is:

1. A mechanical amplifier device, comprising:
an input shaft configured to receive an initial force;
a housing having within:
a first wheel configured to receive the initial force from the input shaft, wherein the input shaft enables synchronous rotation of the first wheel and a second wheel;
a lever configured to receive the initial force transferred from the first wheel, where the lever is attached to an outer edge of the first wheel, enabling movement of the lever to amplify the initial force;
the lever traverses a center of a fulcrum accommodated in a fulcrum housing and attaches to an outer edge of the second wheel to transfer the amplified initial force to the second wheel; and
an output shaft configured to rotate upon receiving the amplified initial force from the second wheel, and configured to provide the amplified initial force to an external machine.

2. The mechanical amplifier device according to claim 1, wherein the initial force is an external force generated from sources such as a lever, a button, a motor, an engine, a crank, a pump, wind movement, water movement, a pulley system, hydraulic means, gravity, or human power.

3. The mechanical amplifier device according to claim 1, wherein the initial force is a rotational force and the amplified initial force is an amplified rotational force.

4. The mechanical amplifier device according to claim 1, wherein the input shaft is connected with an input shaft bearing to enable rotational movement.

5. The mechanical amplifier device according to claim 1, wherein the output shaft is connected with an output shaft bearing to enable rotational movement.

6. The mechanical amplifier device according to claim 1, wherein a longer end of the lever is attached to the outer edge of the first wheel at a first connection point.

7. The mechanical amplifier device according to claim 1, wherein a shorter end of the lever is attached to the outer edge of the second wheel at a second connection point.

8. The mechanical amplifier device according to claim 1, wherein the first wheel is connected to the second wheel once the lever has passed through the center of the fulcrum.

9. The mechanical amplifier device according to claim 1, wherein the input shaft, the lever and the output shaft are placed along a same horizontal axis.

10. The mechanical amplifier device according to claim 1, wherein the first wheel is larger than the second wheel.

11. The mechanical amplifier device according to claim 1, wherein the fulcrum and the lever are configured to accept force in a 360 degree range of motion.

12. The mechanical amplifier device according to claim 1, wherein the external machine is a bicycle.

13. A bicycle employing a mechanical amplifying device, comprising:
a first gear and a second gear, the second gear configured to interlock a pedal bike teeth from one end and configured to connect to a mechanical amplifier device from another end;
the mechanical device comprises:
an input shaft configured to receive an initial force;
a housing, comprising:
a first wheel configured to receive the initial force from the input shaft, wherein the input shaft enables synchronous rotation of the first wheel;
a lever configured to receive the initial force transferred from the first wheel, while the lever is attached to an outer edge of the first wheel, enabling rotation of the lever to amplify the initial force;
wherein the lever passes through a center of a fulcrum accommodated in a fulcrum housing and attaches to an outer edge of a second wheel to provide the amplified initial force to the second wheel; the amplified initial force causes rotation of the second wheel; and
an output shaft configured to rotate synchronously upon receiving the amplified initial force from the second wheel;
wherein the first gear is configured to receive the amplified initial force from the output shaft, and transfer the amplified initial force to an interlocked sprocket.

14. The bicycle according to claim 13 comprises a pair of pedals to receive the initial force.

15. The bicycle according to claim 13, wherein the initial force is a rotational force and the amplified initial force is an amplified rotational force.

16. The bicycle according to claim 13, wherein a longer end of the lever is attached to the outer edge of the first wheel at a first connection point.

17. The bicycle according to claim 13, wherein a shorter end of the lever is attached to the outer edge of the second wheel at a second connection point.

18. The bicycle according to claim 13, wherein the first wheel is connected to the second wheel once the lever has passed through the center of the fulcrum.

19. The bicycle according to claim 13, wherein the first wheel is larger than the second wheel.

20. The bicycle according to claim 13, wherein the fulcrum and the lever are configured to accept force in a 360 degree range of motion.
